(19) United States
(12) Patent Application Publication
(10) Pub. No.: US 2026/0362525 A1
(43) Pub. Date: Nov. 12, 2026

(54) IDENTIFYING ROAMING REQUEST FRAME FOR SECURE ROAMING THROUGH A TARGET ACCESS POINT (AP) MULTI-LINK DEVICE (MLD)

(71) Applicant: Cisco Technology, Inc., San Jose, CA (US)

(72) Inventors: Binita Gupta, San Diego, CA (US); Brian D. Hart, Sunnyvale, CA (US)

(21) Appl. No.: 19/669,105

(22) Filed: May 6, 2026

Related U.S. Application Data
(60) Provisional application No. 63/800,937, filed on May 6, 2025.

(51) Int. Cl. H04W 76/15; H04L 9/06

(52) U.S. Cl. CPC H04W 76/15; H04L 9/0618

(57) ABSTRACT

Identifying a roaming frame type for secure roaming through a target Access Point (AP) may be provided. An action frame may be provided received at a target Access Point (AP) Multi-Link Device (MLD) of a Seamless Mobility Domain (SMD) from a non-AP MLD. The non-AP MLD may be associated with a first AP MLD. Both the target AP MLD and the first AP MLD may be members of the SMD. The target AP MLD may determine from an un-encrypted portion of the action frame that the action frame includes a protected roaming request indicating non-AP MLD’s intent to perform seamless roam to the target AP MLD. The target AP MLD, in response to determining that the action frame comprises the protected roaming request, may prioritize the action frame for processing at the target AP MLD.

### RELATED APPLICATION

Under provisions of 35 U.S.C. § 119(e), Applicant claims the benefit of U.S. Provisional Application No. 63/800,937, filed May 6, 2025, which is incorporated herein by reference.

### TECHNICAL FIELD

The present disclosure relates generally to policies for identifying a roaming request frame for secure roaming through a target Access Point (AP) Multi-Link Device (MLD).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for identifying a roaming request frame for protected roaming through a target Access Point (AP) Multi-Link Device (MLD);

FIG. 2 is a flow chart of a method for identifying a roaming request frame for protected roaming through a target AP MLD;

FIG. 3A illustrates an example structure of an action frame;

FIG. 3B illustrates an example Media Access Control (MAC) header of an action frame;

FIG. 3C illustrates an example structure of a Counter Mode with Cipher Block Chaining Message Authentication Code (CBC-MAC) Protocol (CCMP) header of an action frame; and

FIG. 4 is a block diagram of a computing device.

### DETAILED DESCRIPTION

### Overview

Identifying a roaming request frame for secure roaming through a target Access Point (AP) Multi-Link Device (MLD) may be provided. An action frame may be received at a target Access Point (AP) Multi-Link Device (MLD) of a Seamless Mobility Domain (SMD) from a non-AP MLD. The non-AP MLD may be associated with a first AP MLD. Both the target AP MLD and the first AP MLD may be members of the SMD. The target AP MLD may determine from an un-encrypted portion of the action frame that the action frame includes a protected roaming request indicating non-AP MLD’s intent to perform seamless roam to the target AP MLD. The target AP MLD, in response to determining that the action frame comprises the protected roaming request, may prioritize the action frame for processing at the target AP MLD to achieve faster roaming transition time.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### EXAMPLE IMPLEMENTATIONS

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP) Multi-Link Devices (MLDs). Associating with an SMD may enable the STA to roam seamlessly between member AP MLDs of the SMD without requiring reassociation and reestablishment of contexts with each new AP MLD. That is, associating with an SMD may ensure that when the STA moves from the current AP MLD to a target AP MLD, the STA may not need to perform reassociation, reestablishment of contexts and rekeying, and the STA context may be transferred from the current AP MLD to the target AP MLD to achieve seamless roaming. In one case, rekeying may be performed in advance preparation done for seamless roaming. Thus, by enabling the STA to associate with a SMD that includes multiple member AP MLDs may significantly reduce roaming time to realize seamless roaming (e.g., smooth and continuous roaming with no apparent interruption in data communication) and significantly improve a STA’s wireless performance in terms of increased throughput, reduced latency, and higher range, as illustrative, non-limiting examples.

Seamless roaming may have two phases: a roaming preparation phase and a roaming execution phase. In the roaming preparation phase, the STA prepares a target AP MLD in advance for roaming transition in near future. The roaming preparation phase may involve link setup, context transfer, and Quality-of-Service (QoS) related resource reservation on the target AP MLD and may also involve setting up new keying material for the target AP (e.g. new Per-AP PTK) and transfer of estimated values for dynamic context such as SN (Sequence number) and PN (Packet number). Once a non-AP MLD (that is, the STA) has performed the roaming preparation with a target AP MLD, it then may perform the roaming execution to that target AP MLD to roam to that target AP MLD. The roaming execution phase may further involve latest dynamic context transfer (such as transfer of latest PN and/or SN) and changing a Distribution System (DS) mapping for the non-AP MLD from the current AP MLD to the target AP MLD.

As discussed above, for IEEE 802.11bn seamless roaming with SMD architecture, there may be a need to support STAs directly roaming through a target AP MLD. For example, this may be needed when a STA has to perform an urgent roaming because its Received Signal Strength Indicator (RSSI) degrading suddenly and the STA may not have enough time to perform roaming preparation in advance though its current AP MLD. One approach may be to support direct roaming using secure/encrypted roaming frames protected using Protected Management Frames (PMF), when a shared Pairwise Transient Key (PTK) is used for a non-AP MLD across all the AP MLDs of the SMD. This approach may ensure that the non-AP MLD may perform secure seamless roaming to a target AP MLD using PMF protected roaming request frame and then the target AP MLD may fetch the non-AP MLD's context that was established on the old serving AP MLD.

The protected roaming request that is sent to the target AP MLD may be an action frame with encrypted frame body. If no previous roaming preparation was done with the target AP MLD, then the target AP MLD may not have a shared PTK for the non-AP MLD plumbed into the hardware of the target AP MLD. Then the roaming request may get processed over an error path (since the target AP MLD may not find the shared PTK to decrypt). The error path may typically be a much slower path. For example, in the error path processing, the roaming request may be another treated as action frame and there may not be a way to distinguish it from other action frames in the error path. However, it may be desirable to process the roaming request on a faster or prioritized path, to provide faster roaming through the target AP MLD. Embodiments of the disclosure, therefore, provide processes to identify a roaming request frame early on (among other action frames) and push the roaming request frame on a priority path for further processing and decryption. This may enable faster processing of the roaming request frames leading to achieving a faster roaming time when a non-AP MLD may be roaming directly through a target AP MLD.

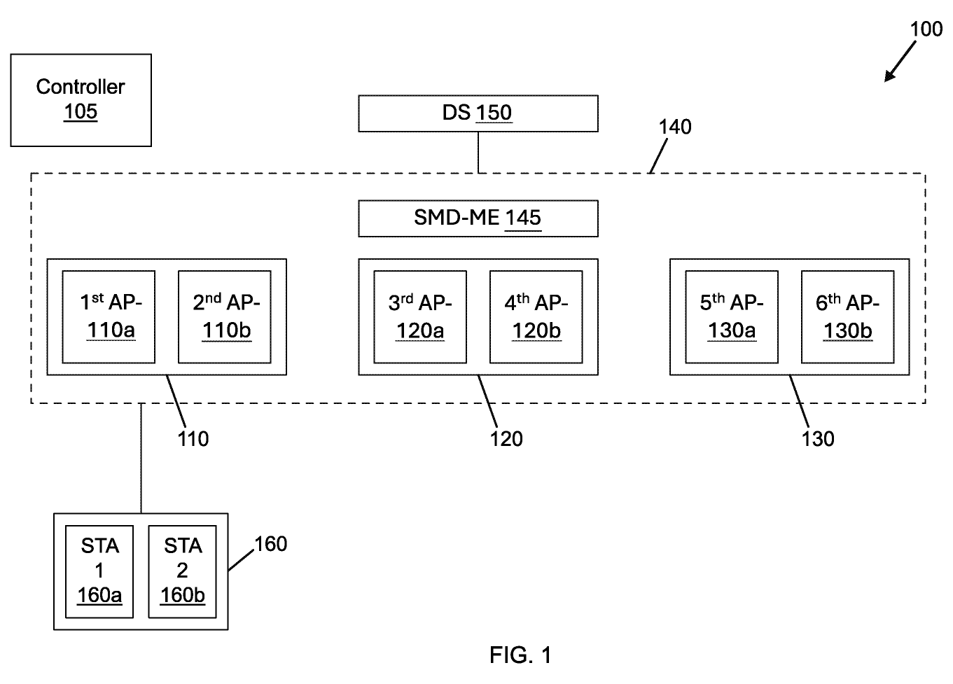

FIG. 1 is a block diagram of an operating environment 100 for identifying a roaming request frame for secure roaming through a target AP MLD. As shown in FIG. 1, operating environment 100 may comprise a controller 105, a plurality of AP MLDs, for example, a first AP MLD 110, a second AP MLD 120, and a third AP MLD 130. Each of the plurality of AP MLDs may include one or more APs (called affiliated APs of the AP MLD). For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include an SMD 140, an SMD Management Entity (SMD ME) 145, a DS 150, and a non-AP MLD 160. Non-AP MLD 160 may include a first STA 160a and a second STA 160b. SMD 140 may include a plurality of AP MLDs (that is, first AP MLD 110, second AP MLD 120, and third AP MLD 130) each with a Media Access Control (MAC)-Service Access Point (SAP) to DS 150.

SMD ME 145 may enable converged architecture for the plurality of AP MLDs of SMD 140. SMD ME 145 may enable seamless roaming between the plurality of AP MLDs which enables a non-AP MLD 160 to roam seamlessly between member AP MLDs without requiring reassociation and reestablishment of contexts with each new AP MLD. SMD ME 145 may be a logical entity and may be hosted on controller 105 or distributed on one or more of first AP MLD 110, second AP MLD 120, and third AP MLD 130. DS 150 may include wired ethernet or a wireless backhaul network used to connect multiple AP MLDs of SMD 140.

SMD 140 may provide a coverage environment, for example, but is not limited to, a Wireless LAN (WLAN) that may provide wireless network access (e.g., access to the WLAN for non-AP MLD 160 as it moves within the coverage environment). First STA 160a and second STA 160b each may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Each of the plurality of APs may be compatible with specification standards such as, but not limited to, the IEEE 802.11 specification standard for example. The plurality of APs and STAs of operating environment 100 may use Multi-Link Operation (MLO) where they simultaneously transmit and receive across different bands and channels by establishing two or more links to two or more AP radios. These bands may comprise, but are not limited to the 2.4 GHz band, the 5 GHz band, the 6 GHz band, and the 60 GHz band.

Controller 105 may comprise a WLC and may provision and control the coverage environment (for example, a WLAN). In some implementations of the disclosure, controller 105 may be implemented by a Digital Network Architecture Center (DNAC) controller (i.e., a Software-Defined Network (SDN) controller.

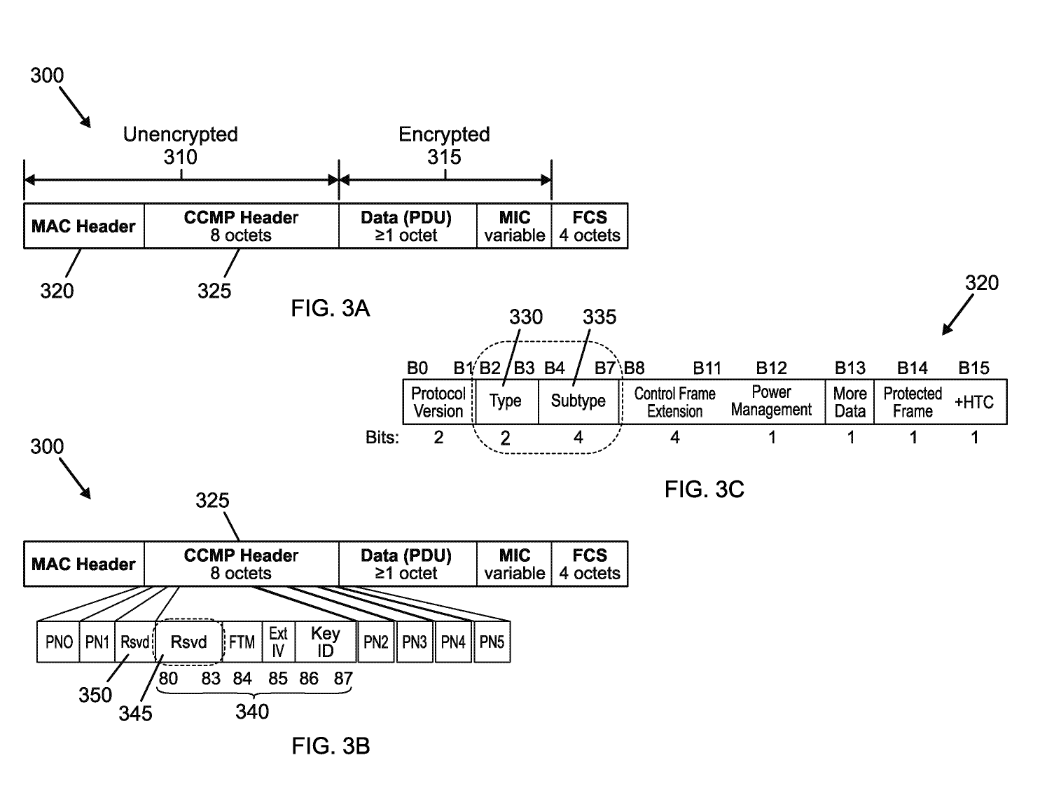

The elements described above of operating environment 100 (e.g., controller 105, first AP MLD 110, second AP MLD 120, third AP MLD 130, SMD 140, SMD ME 145, DS 150, and non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

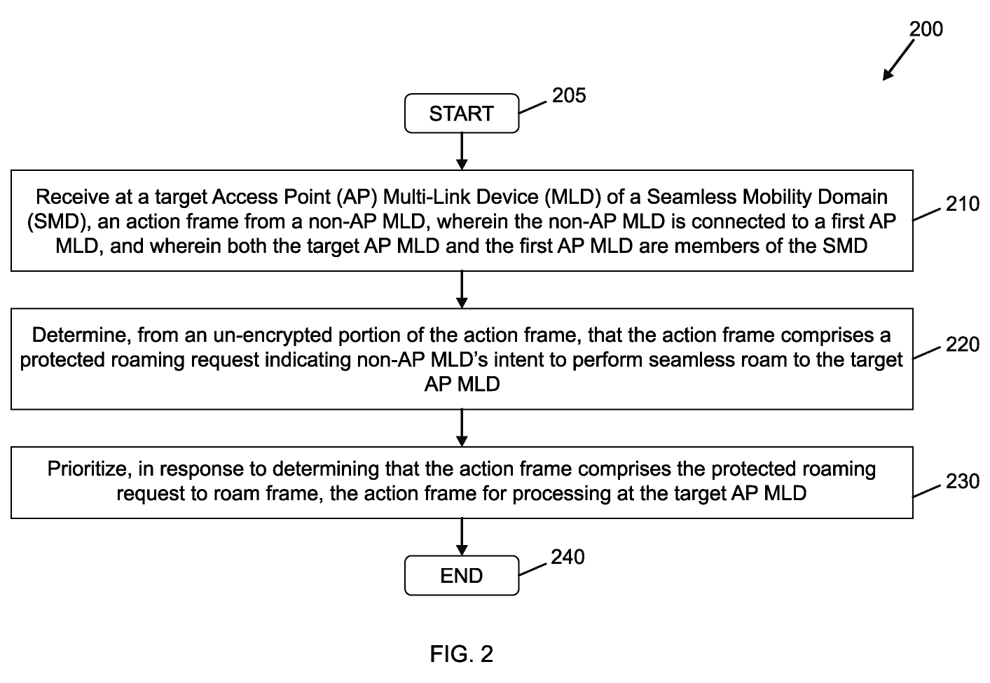

FIG. 2 is a flow chart setting forth the general stages involved in a first method 200 consistent with implementations of the disclosure for identifying a roaming frame type for secure roaming through a target AP MLD. First method 200 may be implemented using any of first AP MLD 110, second AP MLD 120, third AP MLD 130, or SMD 140 as described in more detail above with respect to FIG. 1. In some examples, first method 200 may be implemented using any of the plurality of AP MLDs as described in more detail above with respect to FIG. 1. Ways to implement the stages of method 200 will be described in greater detail below.

Method 200 may begin at starting block 205 and proceed to stage 210 where a target AP MLD (for example, second AP MLD 120) may receive an action frame from non-AP MLD 160. As discussed above, non-AP MLD 160 may be associated with first AP MLD 110, and both the target AP MLD (that is, second AP MLD) and first AP MLD 110 may be members of SMD 140. Non-AP MLD 160 may be intending to or preparing to roam to the target AP MLD (that is, second AP MLD 120) and therefore may send a roaming request as an action frame directly to the target AP MLD (that is, second AP MLD 120). As discussed above, the action frame for the roaming request may be encrypted with an encrypted frame body.

In one example implementation, the action frame for the roaming request may be modified to indicate in its un-encrypted portion that it may include a roaming request or is a protected roaming request frame. Hence, upon receiving such action frame, the target AP MLD (that is, second AP MLD 120) may determine without decrypting or having to decrypt, that the action frame corresponds to a protected roaming request. In an example implementation, a roam request indicator may be provided in unencrypted portion of the action frame to indicate that the action frame corresponds to a roaming request to roam to the target AP MLD (that is, second AP MLD 120).

FIG. 3A illustrates an example structure of an action frame 300. As shown in FIG. 3A, action frame 300 may include an unencrypted portion 310 and an encrypted portion 315. Unencrypted portion 310 may include an address field 320 and an encryption header field 325. In one example, address field 320 may be a MAC header and encryption header field 325 may be a Counter Mode with Cipher Block Chaining Message Authentication Code (CBC-MAC) Protocol (CCMP) header or a Galois/Counter Mode protocol (GCMP) header.

In a first example implementation, the roam request indicator may be provided in address field 320 (that is, MAC header 320). FIG. 3B illustrates an example MAC header 320 of an action frame. As shown in FIG. 3B, MAC header 320 may include a plurality of fields, including a type field 330 and a subtype field 335, indicating the type and subtype for the action frame. In some examples, type field 330 may be two bits long and subtype filed 335 may be four bits long. Both, type field 330 and subtype field 335 may be used to include the roam request indicator. In a first example, the roam request indicator may be provided as a first value indicated in type field 330 and a second value indicated in subtype field 335. For example, the roam request indicator may be provided as a new subtype under extension type (11) as:
Type = Extension (11), Subtype = 0010 (or another reserved value).

In another example, the roam request indicator may be indicated under management type (10) with a subtype value of (1111). That is, the roam request indicator may be provided under extension type (10) as:
Type = management (10), Subtype = 1111.

In yet another example, the subtype definition may be extended so that a new sub-subtype value or field may be defined for the roam request indicator for roaming through the target AP. For type=management (10) and Subtype=1111, MAC header 320 may contain another management control field (for example, Quality of Service (QoS) control field, or a High Throughput (HT) control field, etc.), and this field may include a sub-subtype field that may indicate more subtypes for the frames. The management control field may be of 1, 2, 4, or more octets, or a selection among a finite number of octets depending on a length field in the first octet (e.g., 1-2-4-8 bits of length information). This way the subtype field may be extended to define more subtypes. One of the sub-subtype field values may signal the roam request indicator for roaming through the target AP MLD (that is, second AP MLD 120).

In a second example implementation, the roam request indicator may be provided in encryption header field 325 (that is, CCMP header or GCMP header 325). More specifically, one of the bits in a key identifier (Key ID) octet of CCMP header or GCMP header 325 may be used to signal that the action frame is a protected roaming request frame used for seamless roaming through the target AP.

FIG. 3C illustrates an example structure of CCMP header 325 of action frame 300. As shown in FIG. 3C, CCMP header 325, may include a key identifier octet 340. Key identifier octet 340 may include a plurality of fields, including a first reserved field 345. In one example, one of the bits in first reserved field 345 (that is, B0 to B3) in key identifier octet 340 may be used to indicate that the action frame is a protected roaming frame (or protected roaming request frame) used for seamless roaming through the target AP. A similar indicator may be provided in a Galois/Counter Mode Protocol (GCMP) header. In another example, a second reserved field 350 after a Packet Number 1 (PN1) field may be used to indicate that the action frame is a protected roaming frame used for roaming through the target AP MLD. This indication that the action frame is a protected roaming frame used for roaming through the target AP can be signaled as part of any other fields in the CCMP or GCMP header or headers used for other encryption algorithms.

In one implementation, when a Fine Time Management (FTM) feature is not used by non-AP MLD 160 and/or the target AP (that is, support is not indicated for a FTM initiator and/or a FTM responder using capability bits in an extended capabilities element), then a FTM bit (B4 in key identifier octet 340) may also be used to indicate that the action frame is a protected roaming frame used for roaming through the target AP MLD.

After receiving the action frame from non-AP MLD 160 at stage 210, method 200 may proceed to stage 220 where the target AP MLD (that is, second AP MLD 120) may determine, from an un-encrypted portion of the action frame, that the action frame comprises a protected roaming request indicating non-AP MLD’s 160 intent to perform seamless roam to the target AP MLD (that is, second AP MLD 120). Since, the action frame is a protected roaming request the target AP MLD (that is, second AP MLD 120) may not be able to process it without decrypting unless it has a PTK saved.

Once having determined that the action frame comprises the protected roaming request at stage 220, method 200 may proceed to stage 230 where first AP MLD 110 may prioritize, in response to determining that the action frame comprises the protected roaming request, the action frame for processing at the target AP MLD (that is, second AP MLD 120). In example, the target AP MLD (that is, second AP MLD 120) may move the action frame in response to determining that the action frame comprises the protected roaming request to a faster processing queue from a regular processing queue. This may expedite faster processing of the action frame comprising the protected roaming request compared to some other action frames received at the target AP MLD (that is, second AP MLD 120).

In examples, when non-AP MLD 160 is roaming through the target AP MLD (that is, second AP MLD 120) and uses a protected roaming request (for example, a PMF protected Ultra High Reliability (UHR) link reconfiguration request frame), it may then use either the type/subtype values described above or may use type/subtype/sub-subtype values to signal that the action frame is a protected roaming request for roaming to the target AP MLD (that is, second AP MLD 120). The target AP MLD (that is, second AP MLD 120) may then identify the action frame accordingly using the corresponding fields and prioritize the action frame for faster processing path to achieve a faster roaming time, when non-AP MLD 160 is performing a secure roaming to the target AP MLD (that is, second AP MLD 120).

When non-AP MLD 160 sends a protected roaming request frame, for example, an encrypted UHR link reconfiguration request frame) directly to the target AP MLD (for example, second AP MLD 120) to perform seamless roaming through the target AP MLD (that is, second AP MLD 120), then non-AP MLD 160 may signal this frame type by setting an appropriate bit/field in CCMP header 325 (or GCMP header) of the encrypted roaming request frame. The target AP MLD (that is, second AP MLD 120) may then identify the action frame accordingly using the corresponding fields and prioritize the action frame for faster processing path to achieve a faster roaming time, when non-AP MLD 160 is performing a secure roaming to the target AP MLD (that is, second AP MLD 120). Once having prioritized the action frame for faster processing at the target AP MLD at stage 230, method 200 may terminate at end block 240.

Embodiments of the disclosure may provide extensions to type/subtype in MAC header 320 or extensions to CCMP header 325 (and/or a GCMP header) to identify that the action frame is a protected roaming request frame used for seamless roaming through a target AP MLD (that is, second AP MLD 120). This may enable faster processing of such roaming request frames leading to achieving faster roaming time when non-AP MLD 160 is roaming through the target AP MLD (that is, second AP MLD 120).

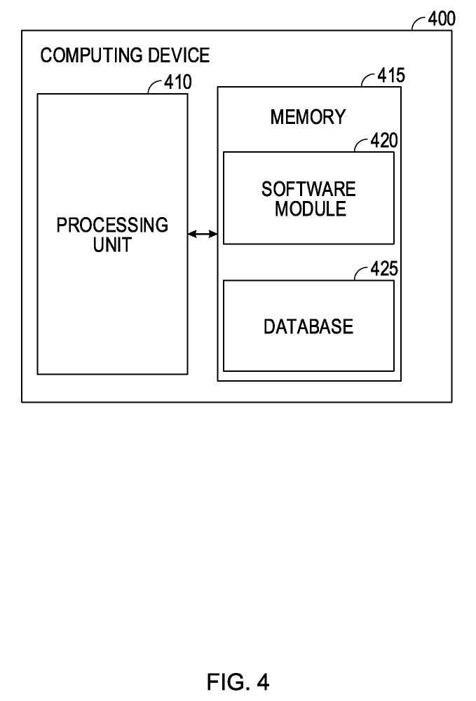

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for enabling policies identifying a roaming frame type for protected roaming through a target AP as described above with respect to FIG. 2. Computing device 400, for example, may provide an operating environment for controller 105, first AP MLD 110, second AP MLD 120, third AP MLD 130, SMD 140, SMD-ME 145, DS 150, and non-AP MLD 160. Controller 105, first AP MLD 110, second AP MLD 120, third AP MLD 130, SMD 140, SMD-ME 145, DS 150, and non-AP MLD 160 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 600 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, at a target Access Point (AP) Multi-Link Device (MLD) of a Seamless Mobility Domain (SMD), an action frame from a non-AP MLD, wherein the non-AP MLD is associated with a first AP MLD, and wherein both the target AP MLD and the first AP MLD are members of the SMD;
determining, by the target AP MLD from an un-encrypted portion of the action frame, that the action frame comprises a protected roaming request indicating non-AP MLD’s intent to perform seamless roam to the target AP MLD; and
prioritizing, by the target AP MLD in response to determining that the action frame comprises the protected roaming request, the action frame for processing at the target AP MLD.

2. The method of claim 1, wherein determining that the action frame comprises the protected roaming request includes determining that an unencrypted portion of the action frame comprises a roaming request indicator.

3. The method of claim 1, wherein the action frame is modified to include a roaming request indicator in an un-encrypted portion of the action frame.

4. The method of claim 3, wherein the roaming request indicator is included in a Media Access Control (MAC) header of the action frame.

5. The method of claim 4, wherein the roaming request indicator is included in a type field and a subtype field of the MAC header of the action frame.

6. The method of claim 3, wherein the roaming request indicator is included in a Counter Mode with Cipher Block Chaining Message Authentication Code (CBC-MAC) Protocol (CCMP) header of the action frame.

7. The method of claim 6, wherein the roaming request indicator is included in a key identifier octet of the CCMP header of the action frame.

8. A system comprising:
a memory storage; and
a processing unit coupled to the memory storage, wherein the processing unit is operative to:
receive, at a target Access Point (AP) Multi-Link Device (MLD) of a Seamless Mobility Domain (SMD), an action frame from a non-AP MLD, wherein the non-AP MLD is associated with a first AP MLD, and wherein both the target AP MLD and the first AP MLD are members of the SMD;
determine, by the target AP MLD from an un-encrypted portion of the action frame, that the action frame comprises a protected roaming request indicating non-AP MLD’s intent to perform seamless roam to the target AP MLD; and
prioritize, by the target AP MLD in response to determining that the action frame comprises the protected roaming request, the action frame for processing at the target AP MLD.

9. The system of claim 8, wherein the processing unit being operative to determine that the action frame comprises the protected roaming request includes the processing unit being operative to determine that an unencrypted portion of the action frame comprises a roaming request indicator.

10. The system of claim 9, wherein the action frame is modified to include the roaming request indicator in an un-encrypted portion of the action frame.

11. The system of claim 9, wherein the roaming request indicator is included in a Media Access Control (MAC) header of the action frame.

12. The system of claim 11, wherein the roaming request indicator is included in a type field and a subtype field of the MAC header of the action frame.

13. The system of claim 9, wherein the roaming request indicator is included in a Counter Mode with Cipher Block Chaining Message Authentication Code (CBC-MAC) Protocol (CCMP) header of the action frame.

14. The system of claim 13, wherein the roaming request indicator is included in a key identifier octet of the CCMP header of the action frame.

15. A non-transitory computer-readable medium that stores a set of instructions which when executed perform a method executed by the set of instructions comprising:
receiving, at a target Access Point (AP) Multi-Link Device (MLD) of a Seamless Mobility Domain (SMD), an action frame from a non-AP MLD, wherein the non-AP MLD is associated with a first AP MLD, and wherein both the target AP MLD and the first AP MLD are members of the SMD;
determining, by the target AP MLD from an un-encrypted portion of the action frame, that the action frame comprises a protected roaming request indicating non-AP MLD’s intent to perform seamless roam to the target AP MLD; and
prioritizing, by the target AP MLD in response to determining that the action frame comprises the protected roaming request, the action frame for processing at the target AP MLD.

16. The non-transitory computer readable medium of claim 15, determining that the action frame comprises the protected roaming request includes determining that an unencrypted portion of the action frame comprises a roaming request indicator.

17. The non-transitory computer-readable medium of claim 16, wherein the roaming request indicator is included in a Media Access Control (MAC) header of the action frame.

18. The non-transitory computer-readable medium of claim 17, wherein the roaming request indicator is included in a type field and a subtype field of the MAC header of the action frame.

19. The non-transitory computer-readable medium of claim 16, wherein the roaming request indicator is included in a Counter Mode with Cipher Block Chaining Message Authentication Code (CBC-MAC) Protocol (CCMP) header of the action frame.

20. The non-transitory computer-readable medium of claim 19, wherein the roaming request indicator is included in a key identifier octet of the CCMP header of the action frame.
